(19) United States
(12) Patent Application Publication
(10) Pub. No.: US 2007/0110957 A1
(43) Pub. Date: May 17, 2007

(54) Anisotropic diffusing medium and production method therefor

(76) Inventors: Kensaku Higashi, Shizuoka-shi (JP); Makoto Murata, Shizuoka-shi (JP); Yukio Yamaguchi, Kawasaki-shi (JP); Takafumi Uematsu, Nagareyama-shi (JP)

Correspondence Address: OLIFF & BERRIDGE, PLC, P.O. BOX 19928, ALEXANDRIA, VA, 22320, US

(21) Appl. No.: 10/592,388

(22) PCT Filed: Mar. 15, 2005
(86) PCT No.: PCT/JP05/04539

§ 371 Date: Dec. 6, 2006

(30) Foreign Application Priority Data
Mar. 16, 2004 (JP) 2004-074180
Mar. 31, 2004 (JP) 2004-103351
Mar. 31, 2004 (JP) 2004-103376

(51) Int. Cl. B32B 27/16; B29D 11/00

(52) U.S. Cl. 428/141; 264/1.34; 264/1.36

(57) ABSTRACT

In an anisotropic diffusing medium having a resin layer comprising a cured composition containing a photo-curable compound, an aggregation of plural pillar-shaped cured areas is formed inside the resin layer, the plural pillar-shaped cured areas all extend collimated to a specific direction P, and in the case in which the amount of each linear transmitted light corresponding to each incident light from all directions to an arbitrary input point on one side of the anisotropic diffusing medium are displayed by vectors beginning at an output point on the other side of the anisotropic diffusing medium corresponding to the input point to each direction of output, the rounded surface obtained by connecting the top of the vectors is a bell shaped rounded surface having a symmetric axis in direction P.

### TECHNICAL FIELD

The present invention relates to an anisotropic diffusing medium in which an amount of transmitted light varies greatly depending on incident angle, to an anisotropic diffusing medium in which diffusing properties of transmitted light varies depending on incident angle, and to a production method therefor.

### BACKGROUND ART

A member exhibiting light diffusion has been conventionally used as a lighting device or a building material, and in recent displays, in particular, the member is widely used in LCDs. As mechanisms for exhibiting light diffusion of these members, there are scattering by convex and concave parts formed on a surface (surface scattering), scattering by difference of refractive indexes of a matrix resin and a filler dispersed therein (internal scattering), and scattering by both surface scattering and the internal scattering. Generally, diffusion performance of these light diffusing members are isotropic; therefore, diffusion properties of the transmitted light do not change greatly even if an incident angle is changed to some extent.

However, a light controlling plate which can selectively scatter a particular incident light is suggested in Japanese Unexamined Patent Application Publication (hereinafter referred to as Japanese Publication) No. Hei01(1989)-77001. This light controlling plate which is a special light diffusing member, is a plastic sheet in which ultraviolet light is irradiated from a certain direction to a resin composition comprising plural compounds each having at least one photopolymerizing carbon-carbon double bond in molecules thereof, and each having mutually different refraction indexes. The sheet selectively scatters only an incident light having a certain angle relative to the sheet.

As a material to produce the light controlling plate, in addition to the above-mentioned “resin composition comprising plural compounds each having at least one photopolymerizing carbon-carbon double bond in molecules thereof and each having mutually different refractive indexes”, a composition including urethane acrylate oligomer is disclosed in Japanese Publication No. Hei01(1989)-147405, No. Hei01(1989)-147406, and No. Hei02(1990)-54201. Furthermore, a combination of compound A having a polymerizing carbon-carbon double bond in molecules thereof and compound B not having a polymerizing carbon-carbon double bond and having a difference of refraction index of not less than 0.01 compared to the compound A, may be mentioned, and a compound having plural polymerizing carbon-carbon double bonds in molecules thereof and having differences in refraction index of not less than 0.01 before and after curing, is mentioned in Japanese Publication No. Hei03(1991)-109501. Furthermore, a combination of a radical polymerizing compound and a cationic polymerizing compound having vinyl ether in its functional group is disclosed in Japanese Publication No. Hei06(1994)-9714.

As a production method for the light controlling plate, a method in which light controlling plates having mutually different angular properties are layered to obtain plural angular selective scattering is disclosed in Japanese Publication No. Sho63(1988)-309902, a method in which light is irradiated from a linear light source to at least one area of plural divided areas, light is irradiated from a linear light source or point light source from a different angle to the other areas of the plural divided areas, to form plural areas each having mutually different angular ranges of scattering, is disclosed in Japanese Publication No. Hei01 (1989)-40903, a method in which light is irradiated from plural linear light sources arranged mutually separated is disclosed in Japanese Publication No. Hei01(1989)-40905, and a continuous production method in which a linear light source is arranged along a width direction of a membrane body of a photopolymerizing composition and the membrane body is moved along a longitudinal direction, is suggested in Japanese Publication No. Hei02(1990)-67501.

However, the incident angle dependence properties of scattering properties, in which incident light from a certain angle is selectively scattered, is observed in the case in which the light controlling plate is revolved around a line at which the linear light source arranged above the light controlling plate during the production process of the light controlling plate is projected onto the surface of the light controlling plate, as illustrated in Japanese Publication No. Hei01(1989)-147405. That is, in the case in which the light controlling plate is revolved around a line perpendicular to the projected line of the linear light source, the incident angle dependence property of the scattering property is only slightly observed, or an incident angle dependence property of the scattering property that is very different from the former case is observed.

FIG. 1 shows a diagram of the conventional light controlling plate. As shown in FIG. 1, in the conventional light controlling plate, it is said that flat areas having mutually different refractive indexes are formed collimated in the sheet material. FIG. 2A shows an electron micrograph of a cross section divided by line A-A in FIG. 1, and FIG. 2B shows an electron micrograph of a cross section divided by line B-B in FIG. 1. As shown in the Figures, in the conventional light controlling plate, areas having mutually different refractive indexes are alternately observed viewed from the cross section divided by the A-A line; however, no change in refractive index is observed, that is, it is uniform viewed from the cross section divided by the B-B line. That is, an incident angle dependence property is observed in the cross section divided by the A-A line, and the incident angle dependence property is only slightly observed in the cross section divided by the B-B line.

The basis of the forming of the light controlling units is not necessarily clear. However, since Japanese Publication No. Hei02(1990)-51101 discloses that “curing is performed to orient areas of different refractive index in a certain direction”, during the photopolymerization process of the photopolymerizing composition, it is assumed that the reaction is promoted spatially non-uniformly to form a fine structure having differing refractive index. To exhibit the incident angle dependence property of the scattering property which can selectively scatter only incident light from a certain angle, it is necessary that areas having different refractive index be regularly oriented in a certain direction, and it seems to be necessary to irradiate light from a linear light source. That is, Japanese Publications No. Hei01(1989)-40903, No. Hei01(1989)-40906, and No. Hei03(1991)-87701 disclose that by using a surface light source or a diffusing light source, the light controlling plate becomes transparent since the fine structures are not formed, and by using a point light source or collimated light source, despite the fine structures being formed, light scattering not having a directional property is exhibited since the fine structures are not regularly formed.

The above-explained light controlling plate exhibits specific light diffusing properties; however, the incident angle dependence property of the scattering property is exhibited only in the case in which it is revolved in a certain direction, and therefore, it is only applied to a construction material to limit viewing in a certain direction.

An optical film, a so-called light control film, or a louver film, which permits transmitting of incident light from a certain range of angles and blocks the light from outside this range, is known. It has been conventionally used as a backlight of an instrument panel, and it is recently used as a viewing angle control of display, that is, to prevent unauthorized viewing. According to Japanese Publication No. Sho50(1975)-92751 and Japanese Patent No. 3043069, this film can be obtained by multiply layering a transparent plastic layer and a colored plastic layer alternately to form a block, and shaving the block perpendicularly or at a certain angle to the plastic layer. This louver film has a structure in which the colored louvers are equally spaced at a certain slope to the thickness direction of the film, and therefore, light collimated to the direction of the louver is transmitted, whereas light which passes through plural neighboring louvers is absorbed at the louver and the light cannot be transmitted.

However, despite the louver film exhibiting anisotropy in which incident light from a certain angle is transmitted, the light transmitting property is changed only in the case in which the film is revolved around a direction in which the louver is arranged, similarly to the above-mentioned light controlling plate. The incident angle dependence property of the transmitted light cannot be observed even if the film is revolved around a line perpendicular to the louver.

### DISCLOSURE OF THE INVENTION

Based on the above-mentioned conventional techniques, the inventors aim to improve an anisotropic diffusing medium, and an object of the present invention is to provide an anisotropic diffusing medium exhibiting an incident angle dependence property of the scattering property not only in the case in which the medium is revolved around a certain line in the medium, but also in the case in which the medium is revolved around another line, and a process of production therefor.

As a result of researching to develop a medium which can control surface scattering also, the inventors discovered that convex and concave parts form on the surface of the anisotropic diffusing medium by self-organization when produced by a certain method, and the invention was thereby completed.

Furthermore, an object of the present invention is to provide a production method for an anisotropic diffusing medium, in which the anisotropic diffusing medium can be continuously produced in a wide area. The anisotropic diffusing medium has a resin layer comprising cured materials of compositions containing photo-curable compounds. Aggregations of plural pillar-shaped cured areas form in the resin layer, and all the plural pillar-shaped cured areas extend collimated to a specific direction P.

In the first embodiment of the present invention, the anisotropic diffusing medium has a resin layer comprising cured material of the composition containing the photo-curable compound, aggregations of plural pillar-shaped cured areas formed in the resin layer, and all the plural pillar-shaped cured areas extend collimated to a specific direction P. Furthermore, in the case in which the amount of each linear transmitted light corresponding to each incident light from all directions to an arbitrary input point on one side of the anisotropic diffusing medium are displayed by vectors beginning at an output point on the other side of the anisotropic diffusing medium corresponding to the input point to each direction of output, the rounded surface obtained by connecting the top of the vectors is a bell-shaped rounded surface having a symmetric axis of direction P.

In such an anisotropic diffusing medium, since aggregations of plural pillar-shaped cured areas having different refractive indexes and extending collimated to a specific direction P are formed in the anisotropic diffusing medium, the amount of a linear transmitted light corresponding to the incident light from the specific direction P is minimal, and the amount of a linear transmitted light corresponding to an incident light from a direction inclined from the direction P becomes larger. The amount of the linear transmitted light becomes larger depending on the angle of inclination from the direction P. The amount would become saturated at an angle above a certain angle. That is, the incident angle dependence property of the amount of the linear transmitted light exhibits similar conditions in an arbitrary plane of incidence including the specific direction P. Therefore, in the case in which each amount of linear transmitted light corresponding to each incident light from all directions to an arbitrary point 0 is displayed by vector, a rounded surface obtained by connecting the tops of all the vectors is a bell-shaped rounded surface as shown in FIG. 3.

Furthermore, in the production method of the anisotropic diffusing medium of the present invention, compositions containing photo-curable compounds are made into a sheet shape, and collimated light is irradiated from a point light source arranged in a specific direction P to the sheet to harden the composition and to form aggregations of plural pillar-shaped cured areas extending collimated to the specific direction P in the sheet.

In such a production method, since collimated beams of light are irradiated from a point light source arranged at the specific direction P, an anisotropic diffusing medium of the present invention in which aggregations of plural pillar-shaped cured areas extending collimated to the specific direction P in the resin can be desirably produced.

In addition, the second embodiment of the anisotropic diffusing medium of the present invention is an anisotropic diffusing medium having a resin layer comprising cured material of compositions containing photo-curable compounds, aggregations of plural pillar-shaped cured areas are formed inside the resin layer, all the plural pillar-shaped cured areas are extending collimated to a specific direction P, convex and concave parts are formed at least one surface of the resin layer, and an arithmetic average roughness Ra of the convex and concave parts on the surface and a maximum height of the convex and concave parts Ry satisfy the following formulas (1) and (2).
0.15 μm≦Ra≦1.0 μm (1)
1.0 μm≦Ry≦5.0 μm (2)

Furthermore, in the present invention, an anisotropic diffusing medium, in which a line extending along the specific direction P is the normal line, is provided, and furthermore, an anisotropic diffusing medium having a structure in which an anisotropic diffusing layer having convex and concave parts on the surface is layered on a transparent substrate, is provided.

In addition, as a production method for the anisotropic diffusing medium, the present invention provides a production method in which compositions containing the photo-curable compounds are formed in the shape of sheets, and collimated light is irradiated from a direction of line P to the sheet to harden the composition. Explaining in detail, while collimated light is irradiated from a direction of line P to harden the composition, a surface of the composition from which the collimated light exits can be exposed to the air or can be covered with a flexible sheet.

The convex and concave parts are formed on at least one surface of the resin layer of the anisotropic diffusing medium of the present invention, and the surface has the roughness described above. The convex and concave parts are formed by self-organization during production of the anisotropic diffusing medium. That is, in the production method of the anisotropic diffusing medium of the present invention, compositions containing photo-curable compounds are formed in a sheet shape, and collimated ultraviolet light is irradiated from a point light source arranged at a specific direction P to the sheet to harden the composition and to form aggregations of plural pillar-shaped cured areas in the sheet. Here, the sheet composition containing photo-curable compounds begins to be cured from the side of incidence of the ultraviolet light, and curing is promoted while forming the pillar-shaped cured areas toward a collimated direction to the specific direction P; however, the mechanism is not clear. Furthermore, when the curing reaches the opposite side of incidence of the ultraviolet light, in the case in which the material of the substrate contacting the sheet composition containing the photo-curable compound is flexible, the growing point of the pillar-shaped cured areas would project, and therefore the convex and concave parts are formed on the opposite surface.

As explained above, the anisotropic diffusing medium of the present invention has both the anisotropic diffusing function which results from special internal structures that are aggregations of the pillar-shaped cured areas formed in the sheet, and the isotropic diffusing function which results from the convex and concave shape on the surface corresponding to the pillar-shaped cured areas. Therefore, the convex and concave parts formed on the surface of the anisotropic diffusing medium of the present invention is required to be within the range in the case in which the parts are expressed by a surface roughness based on Japanese Industrial Standard (JIS) B 0601-1994.

Arithmetic average roughness: 0.15 μm≦Ra≦1.0 μm

Maximum height: 1.0 μm≦Ry≦5.0 μm

In the case in which the arithmetic average roughness Ra is less than 0.15 μm, or the maximum height Ry is less than 1.0 μm, the surface is too uniform, and therefore, the isotropic diffusing function resulting from the surface convex and concave parts of the present invention is slightly exhibited undesirably. In the case in which the arithmetic average roughness Ra is more than 1.0 μm, or the maximum height Ry is more than 5.0 μm, the isotropic diffusing function resulting from the surface convex and concave parts is mainly exhibited and the anisotropic diffusing function resulting from the inner structure is slightly exhibited undesirably.

As another embodiment of the production method of the present invention in which compositions containing photo-curable compounds are formed in a sheet shape, collimated light is irradiated from the specific direction P to this sheet to harden the composition to form aggregations of plural pillar-shaped cured areas in the sheet, aggregations of tubular members are arranged between a linear light source and the sheet oriented collimated to the direction P, and light irradiation is performed through the tubular members.

As shown in FIGS. 4 and 5, in the production method of the present invention, light irradiation is performed through aggregations of plural tubular members arranged collimated to the direction P between the linear light source and the sheet composition containing photo-curable compounds. Therefore, part of the light from the linear light source is blocked, and only light collimated to the tubular members can pass through the tubular members to be irradiated to the curable compound. This corresponds to an irradiation condition in which an arbitrary point on the sheet composition containing the photo-curable compound is irradiated from the conventional point light source. Therefore, the anisotropic diffusing medium having an internal structure and optical properties similar to those of an anisotropic diffusing medium produced by the light irradiation by the conventional point light source can be continuously produced in a wider area.

### BRIEF DESCRIPTION OF THE DRAWINGS

FIG. 1 is a diagram showing an example of a conventional light controlling plate.

FIG. 2A is an electron micrograph showing a cross section divided by line A-A (a cross section perpendicular to a direction of the linear light source) of the conventional light diffusing medium of FIG. 1, and FIG. 2B is an electron micrograph showing a cross section divided by line B-B (a cross section collimated to a direction of the linear light source) of the conventional light diffusing medium of FIG. 1.

FIG. 3 is a diagram explaining the incident angle dependence property of the amount of linear transmitted light being transmitted through the anisotropic diffusing medium of the present invention.

FIG. 4 is a cross section showing a production method of the anisotropic diffusing medium of the present invention.

FIG. 5 is a diagram showing a production method of the anisotropic diffusing medium of the present invention.

FIG. 6 is a diagram showing an evaluating method of the incident angle dependence property of the amount of the linear transmitted light of the anisotropic diffusing medium of the present invention (revolved around only line L).

FIG. 7 is a graph showing a relationship of incident angle and amount of linear transmitted light in the evaluation of the incident angle dependence property of the amount of linear transmitted light of the anisotropic diffusing medium.

FIG. 8 is a diagram showing an embodiment of the anisotropic diffusing medium of the present invention.

FIG. 9A is an electron micrograph showing a cross section divided by line A-A of the light diffusing medium of the present invention of FIG. 8, and FIG. 9B is an electron micrograph showing a cross section divided by line B-B (a cross section perpendicular to the cross section divided by line A-A) of the light diffusing medium of the present invention of FIG. 8.

FIG. 10 is a cross section explaining the incident angle dependence property of the amount of linear transmitted light being transmitted through the anisotropic diffusing medium of FIG. 8.

FIG. 11 is a diagram showing another embodiment of the anisotropic diffusing medium of the present invention.

FIG. 12 is a cross section explaining the incident angle dependence property of the amount of linear transmitted light being transmitted through the anisotropic diffusing medium of FIG. 11.

FIG. 13 is a diagram showing the evaluating method of the incident angle dependence property of the amount of linear transmitted light of the anisotropic diffusing medium of the present invention (revolved around lines L and M).

FIG. 14 is a graph showing the relationship of the incident angle and the amount of linear transmitted light in the evaluation of the incident angle dependence property of the amount of linear transmitted light in a conventional light diffusing medium.

FIG. 15 is diagram explaining the incident angle dependence property of the amount of linear transmitted light in the anisotropic diffusing medium of the present invention, which is produced by irradiating collimated light from the specific direction P.

FIG. 16 is a graph showing a relationship of the incident angle and the amount of linear transmitted light in the evaluation of the incident angle dependence property of the amount of linear transmitted light of the anisotropic diffusing medium of the present invention.

FIG. 17 is a diagram showing a method of forming surface convex and concave parts of the anisotropic diffusing medium of the present invention.

FIG. 18 is a diagram showing a method of forming surface convex and concave parts of the anisotropic diffusing medium of the present invention.

FIG. 19 is a diagram showing a method of forming surface convex and concave parts of the anisotropic diffusing medium of the present invention.

FIG. 20 is a graph showing an incident angle dependence property of the amount of linear transmitted light of Example 1.

FIG. 21 is a graph showing an incident angle dependence property of the amount of linear transmitted light of Comparative Example 1.

FIG. 22 is a graph showing a relationship of an incident angle of incident light and the amount of linear transmitted light in Example 2 and Comparative Example 2.

### EXPLANATION OF REFERENCE NUMERALS

1 . . . Anisotropic diffusing medium, 2 . . . Pillar-shaped cured areas, 3 . . . Light receiving part, 4 . . . Linear light source, 5 . . . Tubular cavity, 6 . . . Aggregation of tubular members, 7 . . . Convex part, 8 . . . Concave part, 9 . . . (Transparent) substance, 10 . . . Film substance, I . . . Incident light, T . . . Transmitted light, P . . . Incident direction, P1, P2 . . . Incident planes, S . . . Normal line at surface of the anisotropic diffusing medium

### BEST MODE FOR CARRYING OUT THE INVENTION

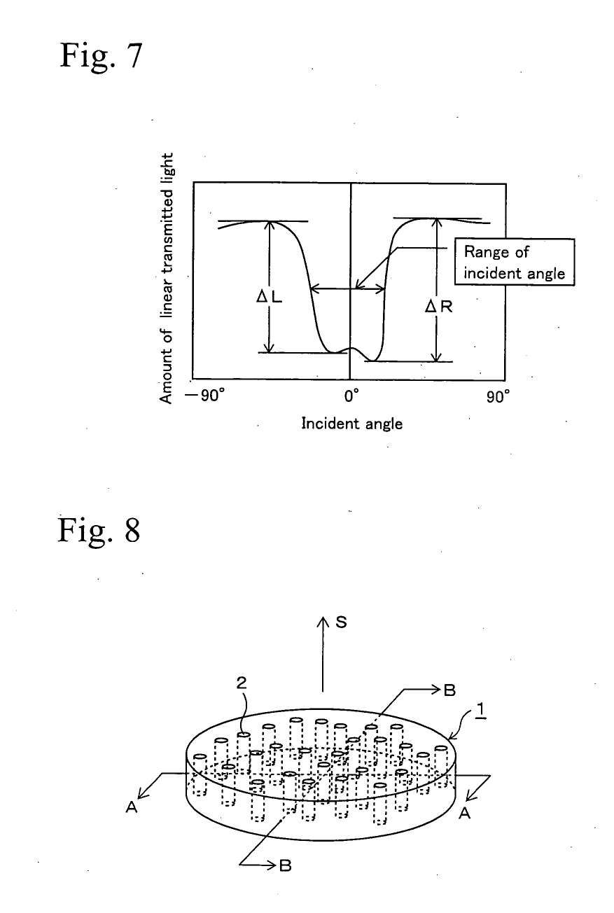

In the anisotropic diffusing medium of the present invention, the incident angle dependence property of the diffusing property is almost the same within an arbitrary incident plane including line P intersecting with the medium surface at a specific angle, and it is symmetric with the line P. Generally, the diffusing property is expressed by a diffusing transmitting ratio, transmitting ratio of collimated light, or Haze value shown in JIS-K7105 or JIS-K7136. These values are measured by adhering a sample to an integrating sphere and irradiating light from the direction of the normal line under conditions preventing light leakage; however, it is not assumed that measurements are taken freely changing the incident angle. That is, there is no publicly known method to evaluate the incident angle dependence property of the diffusing property of an anisotropic diffusing medium. Therefore, in the present invention, as shown in FIG. 6, evaluation of the incident angle dependence property of the amount of linear transmitted light is performed by arranging a sample between a light source (not shown in FIG. 6) and a light receiving device 3, and by measuring the amount of light which is transmitted straight through the sample and enters into the light receiving device 3 while changing the angle of the sample by revolving around line L on the surface of the sample. As a device used specifically, a commercially available hazemeter, bending photometer, and spectrophotometer in which a rotatable sample holder is arranged between the light source and the light receiving part, may be mentioned. Although the value of the light amounts obtained by these measuring devices are relative values, the measured results shown in FIG. 7 were obtained as the incident angle dependence property of the amount of linear transmitted light. The angle dependence property of the scattering property depending on the amount of the linear transmitted light is explained below, but the present invention is not limited in particular thereto, and values of diffusing transmitting ratio, transmitted ratio of collimated light, haze or the like measured by the hazemeter can be used alternatively.

A further explanation of the anisotropic diffusing medium of the present invention follows.

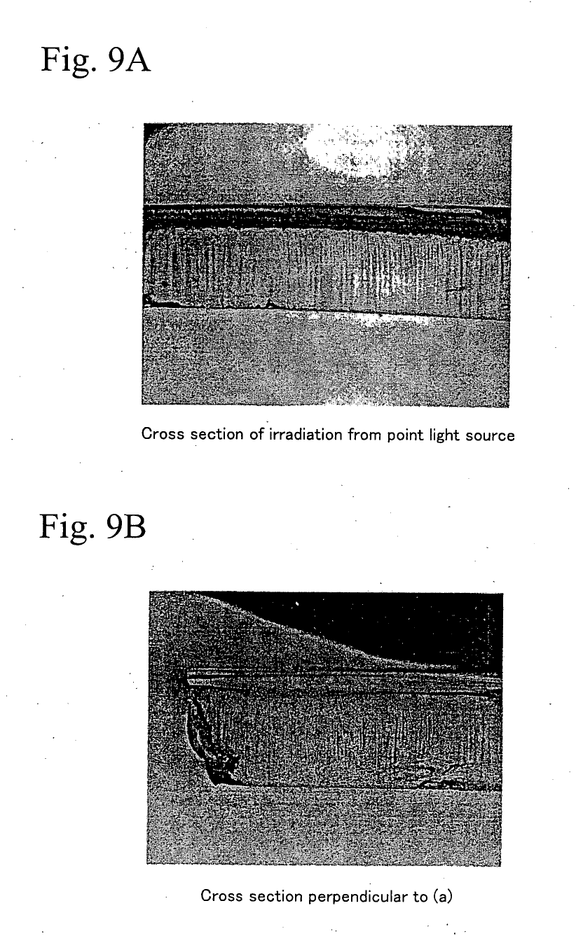

FIG. 8 is a diagram of an embodiment of the anisotropic diffusing medium of the present invention. Inside of the sheet shaped anisotropic diffusing medium 1 comprising cured material of a composition containing a photo-curable compound, there are a large number of fine pillar-shaped cured areas 2. These pillar-shaped cured areas 2 are formed by irradiating mutually collimated ultraviolet light beams from a point light source arranged in the direction of normal line S of the anisotropic diffusing medium 1, and all of these pillar-shaped cured areas extend collimated to a direction of the normal line S. FIGS. 9A and 9B show electron micrographs of a cross section of an example the anisotropic diffusing medium. They correspond to cross sections divided by line A-A and line B-B in FIG. 8. That is, aggregations of pillar-shaped cured areas of the present invention, which are shown schematically in FIG. 8, are based on the electron micrographs shown in FIG. 9, and means a material formed to have such a cross sectional structure. In addition, viewed from the irradiation source, the “pillar-shape” is conceptually drawn as a cylinder in FIG. 8; however, this indicates a condition in which the cured area is formed toward the thickness direction, and the shape is not limited in particular and can be circular, polygonal, or irregular.

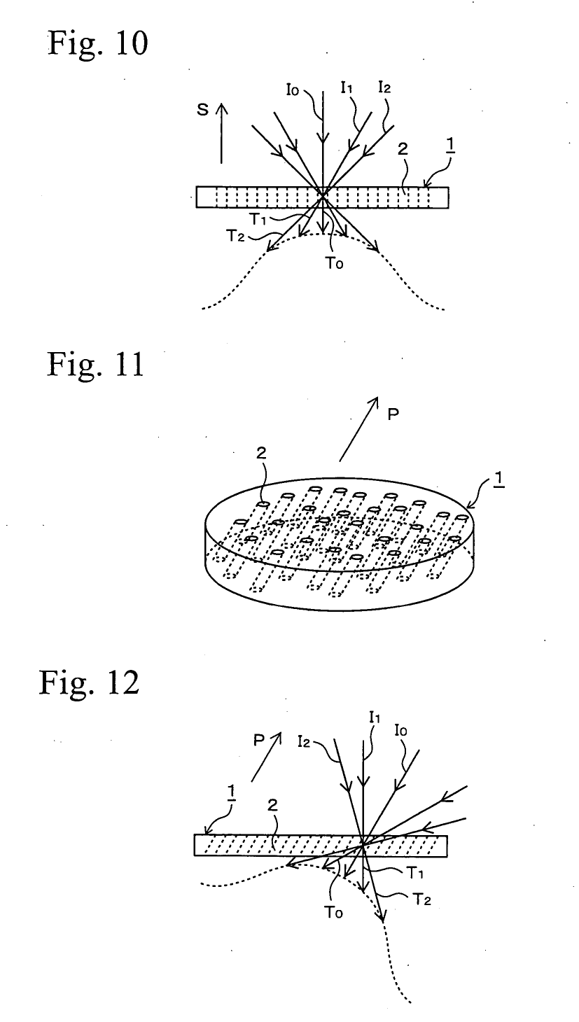

FIG. 10 is a cross section explaining the incident angle dependence property of the amount of linear transmitted light which is transmitted through the anisotropic diffusing medium shown in FIG. 8. In FIG. 10, reference numeral 2 indicates the pillar-shaped cured area conceptually; the pillar-shaped cured area is extending in a direction of normal line S in this case. In the case in which light enters from the upper surface of the anisotropic diffusing medium and exits from the lower surface, the incident light I₀ which enters from a direction of normal line S, that is, the direction of extending of the pillar-shaped cured area, is strongly diffused when the light is passing through the anisotropic diffusing medium, and therefore, the amount of the corresponding linear transmitted light is small. In FIG. 10, this amount is expressed by a transmitted light vector T₀ having a size proportional to the amount of linear transmitted light and having the same direction as I₀. Next, in the case of incident light I₁ inclined to the incident light I₀ at some angle, since the amount of linear transmitted light corresponding to the light I₁ is increased, the transmitted light vector T₁ is larger than T₀. Furthermore, in the case of incident light 12 further inclined to the incident light I₁, the corresponding transmitted light vector T₂ is further larger than T₁.

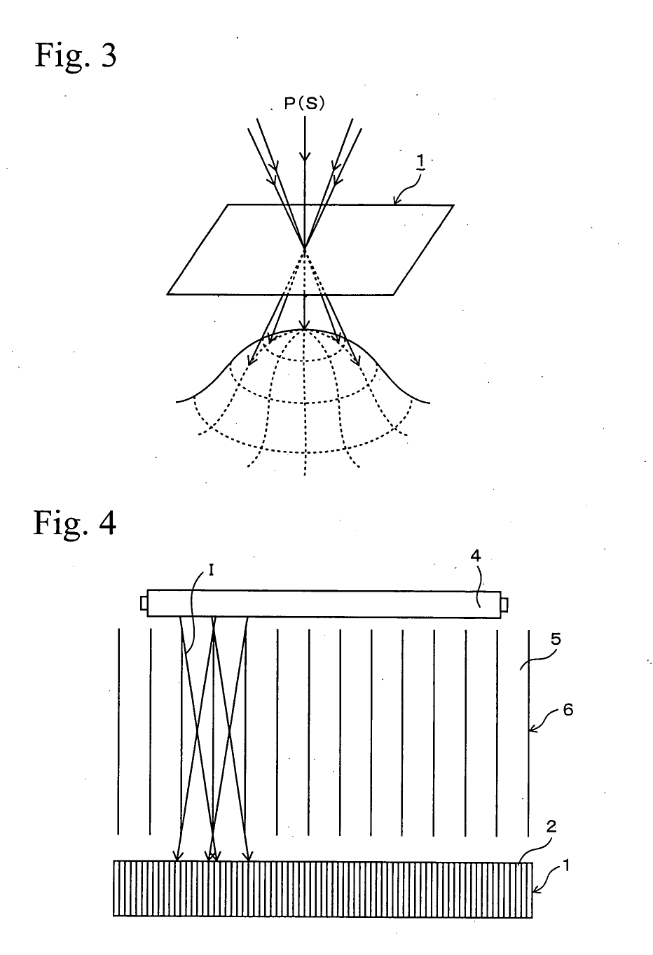

The amount of corresponding transmitted light of all the incident light inclined to the incident light I₀ are expressed by vector in a similar manner as explained above, and connecting the top of all the vectors, a curved line expressed by a dotted line having symmetry shown in FIG. 10 is obtained. Furthermore, in the case in which other cross sections including incident light I₀ are investigated in a similar manner, a dotted curved line as shown in FIG. 10 is obtained in every cross section. That is, if the tops of the transmitted light vectors of all the direction are connected, a bell-shaped curved surface having an axial direction of a normal line S shown in FIG. 3 can be obtained.

The anisotropic diffusing medium of the present invention is not limited only in the above-mentioned embodiments, for example, and an anisotropic diffusing medium having an incident angle dependence property having a symmetric axis of direction P inclined from the direction of normal line S at an arbitrary angle as shown in FIG. 11 is possible.

FIG. 12 is a cross section explaining the incident angle dependence property of the amount of linear transmitted light which is transmitted through the anisotropic diffusing medium shown in FIG. 11. In FIG. 12, reference numeral 2 indicates the pillar-shaped cured area schematically. A similar investigation was performed regarding this anisotropic diffusing medium. By connecting the tops of transmitted light vectors T₀, T₁ and T₂ corresponding to incident light I₀ from the direction P which is a direction of extending of the pillar-shaped cured area, incident light I₁ and 12 inclined to the incident light I₀, a dotted curved line shown in FIG. 12 is obtained. Furthermore, by connecting the tops of transmitted vectors in all the cross sections including the incident light I₀, a bell-shaped curved surface having an axial direction P shown in FIG. 3 can be obtained.

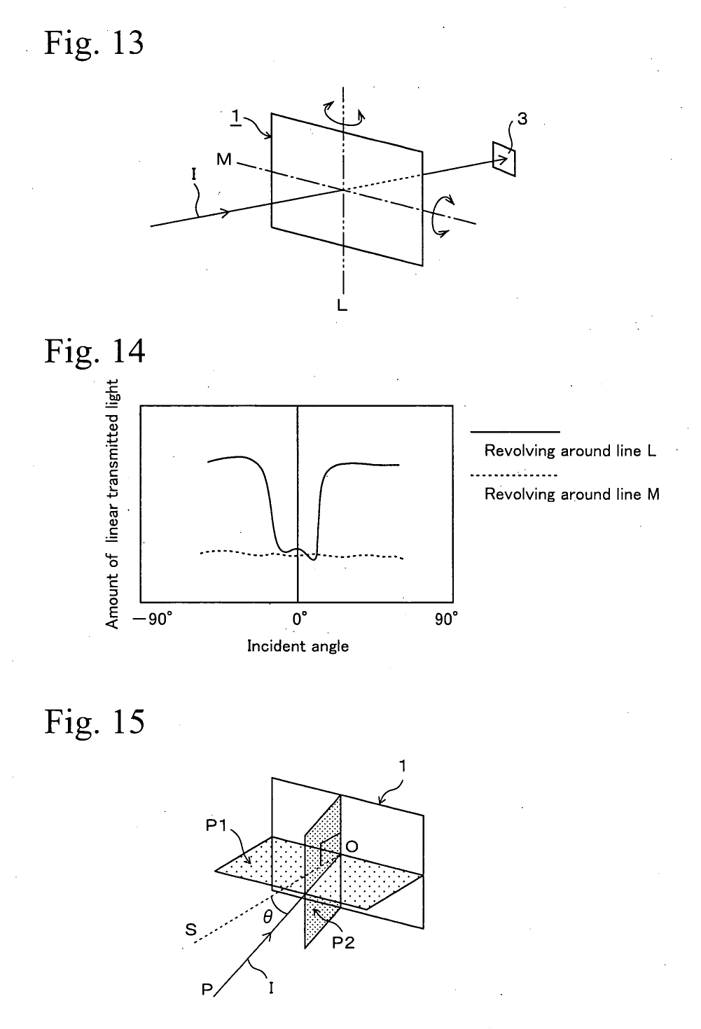

The light controlling plate produced according to Japanese Publication No. Hei01(1989)-77001 can also exhibit similar incident angle dependence properties to that of FIG. 7; however, it is only in the case in which a sample is revolved around a specific line L shown in FIG. 6. If the sample is revolved around a line perpendicular to the line L in the surface of the sample, the incident angle dependence property of the amount of linear transmitted light is only slightly exhibited, or a completely different phenomena is observed. That is, a solid line in FIG. 14 shows the angle dependence property of the amount of linear transmitted light in the case in which a light controlling plate produced by performing light irradiation from a linear light source having the same direction of line L shown in FIG. 13 is revolved around the line L. In the case in which the sample is revolved around the line M perpendicular to the line L, completely different incident angle dependence properties are exhibited as shown by the dotted line.

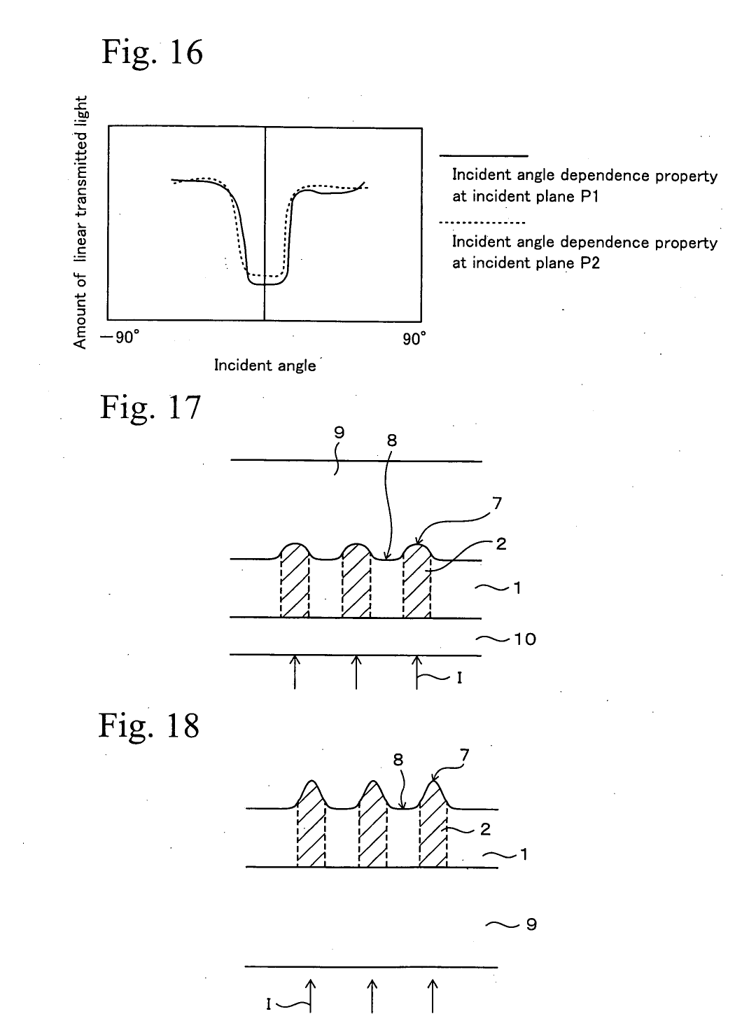

However, the anisotropic diffusing medium of the present invention is produced by irradiating collimated light from the direction of line P to the composition containing a photo-curable compound to harden the compound, the incident angle dependence property of amount of linear transmitted light is almost the same within any incident surface including the line P, and the shape has symmetry around the line P. FIG. 15 shows a line P which represents an incident direction of collimated light irradiated when the anisotropic diffusing medium was produced. An intersection point of the line P and the anisotropic diffusing medium is defined as O, a plane including normal line S of the anisotropic diffusing medium and the line P is defined as incident plane P1, and a plane which is perpendicular to the incident plane P1 and including the line P is defined as incident plane P2. FIG. 16 shows the incident angle dependence property of the amount of linear transmitted light in the incident planes P1 and P2. It should be noted that a direction of the line P is defined as incident angle of 0 degrees, the incident angle dependence property about both incident surfaces are almost same, and the shapes are shown to have symmetry around the line P. This means that if the incident angle dependence property of the amount of linear transmitted light is measured and is made into three dimensions about any incident surfaces including the line P, a bell-shaped body of revolution having the line P as a center can be formed.

In the above explanation, it is explained that the incident angle dependence property of the amount of linear transmitted light is almost the same in any incident planes including the line P, and the “almost the same” is explained below. As shown in the incident angle dependence property of the amount of linear transmitted light in FIG. 7, the amount of linear transmitted light is reduced to exhibit a valley-shape in a specific range of incident angles, and therefore, a half-value width can be defined as a range of incident angles of the anisotropic diffusing property. In the present invention, a case in which the difference of the range of incident angles in mutually different incident planes is not more than 15 degrees, is defined as being “almost the same”.

In the present invention, it is explained that the shape of the incident angle dependence property of the amount of linear transmitted light has symmetry around a specific direction P, the symmetry mentioned here means that ΔR (a difference of maximum and minimum values of the amount of linear transmitted light in a positive area of incident light) and ΔL (a difference of maximum and minimum values of the amount of linear transmitted light in a negative area of incident light) satisfy the following relationship 0.5≦(ΔL/ΔL)≦2, when an incident angle of the incident light directed in the direction P is set to 0 degrees as in FIG. 7.

The anisotropic diffusing medium of the present invention is produced by irradiating collimated beams of light from the direction of line P to the composition containing a photo-curable compound so as to harden the composition. As a direction of the line P, it is necessary that the inclination from the normal line of the medium be not more than 45 degrees, desirably not more than 30 degrees, and more desirably not more than 15 degrees. Furthermore, it is desirable in an embodiment of the invention that the line P be the normal line. In the case in which light is irradiated from an angle not less than 45 degrees, absorption efficiency of the irradiated light is deteriorated, and this is disadvantageous from the viewpoint of production, and furthermore, it is undesirable since coincidence of the incident angle dependence property of the amount of linear transmitted light within an arbitrary incident plane including the line P described in the present invention cannot be maintained. As is clear from FIG. 12, in the case in which the inclination of the direction P to the normal line is large, even if two incident light beams I₂ which are both inclined to the direction P at the same angle enters into the anisotropic diffusing medium, the length of their light paths in the anisotropic diffusing medium differ greatly from each other, and as a result, the light amount corresponding to each transmitted light beam T₂ becomes different.

The anisotropic diffusing medium of the present invention has surface convex and concave parts in addition to the internal structure and optical properties resulting from the structure explained above. As shown in FIG. 17, since the surface convex and concave parts 7 and 8 correspond to the pillar-shaped cured area 2, intervals of the convex parts 7 depend on the diameter of the pillar-shaped cured area, and this can be controlled by the kind and added amount of photo-curable compound and photoinitiator, or an irradiating method of ultraviolet light. The height of the convex and concave parts 7 and 8 can be controlled by selecting the kind and thickness of substrate 9. In the case in which the anisotropic diffusing medium is produced on a substrate having high hardness such as glass or metal, the surface convex and concave parts can be only slightly obtained, whereas on the other hand, in the case in which a substrate has high flexibility such as a PET film, the surface convex and concave parts corresponding to the internal structure mentioned above can be obtained. That is, since the height of the convex and concave parts increases as the flexibility of the substrate increases, by selecting the material and thickness of the substrate, the height of the convex and concave parts can be controlled.

As an embodiment of the anisotropic diffusing medium of the present invention, a single use of an anisotropic diffusing layer comprising the cured material of the composition containing the photo-curable compound, a structure in which the anisotropic diffusing layer layered on a transparent substrate, and a structure in which transparent substrates are layered on both sides of the anisotropic diffusing layer, can be provided. As the transparent substrate, it is desirable that the transparency be high, desirably a full-spectrum transmission (JIS K7361-1) of not less than 80%, more desirably not less than 85%, and most desirably not less than 90%, and furthermore, desirably, a Haze value (JIS K7136) of not more than 3.0, more desirably not more than 1.0, and most desirably not more than 0.5. A transparent plastic film, glass plate or the like can be used, and in particular, the plastic film is desirable from the viewpoints of thinness, portability, shatterproof properties, and productivity. Specifically, polyethylene terephthalate (PET), polyethylene naphthalate (PEN), triacetylcellulose (TAC), polycarbonate (PC), polyarylate, polyimide (PI), aromatic polyamide, polysulfone (PS), polyethersulfone (PES), cellophane, polyethylene (PE), polypropylene (PP), polyvinylalcohol (PVA), cycloolefin resin or the like can be mentioned, and these may be used alone or plurally in a mixture, or be layered. The thickness of the substrate is in a range from 1 μm to 5 mm from the viewpoints of purpose and productivity, desirably 10 to 500 μm, and more desirably 50 to 150 μm.

As a substrate to form the anisotropic diffusing medium of the present invention, in addition to the above-mentioned substrate, a paper made from wood pulp or a synthetic paper can be used. As a paper mainly made from wood pulp, single LBKP or a mixture of NBKP and LBKP can be used. In the case in which NBKP and LBKP are used in a mixture, from the viewpoint of quality of the paper, it is desirable that the added ratio of NBKP be not more than 50%. Furthermore, as long as the strength of a base paper is maintained, recycled used paper can be mixed therein.

For the purpose of improvement in the strength of wood pulp paper used as a base paper, a paper strength enhancing agent can be added. As the paper strength enhancing agent, polyacrylamide based resin, polyamide epichlorohydrin resin, denatured starch such as cationized starch or acetylated starch, melamine resin, urea resin, CMC, guar gum, denatured guar gum, polyamide resin, polyamine resin, epoxy denatured polyamide, or the like can be mentioned.

Furthermore, conventional synthetic paper to which kinds of properties of natural paper are given by preparing various types of synthetic resin as a main raw material, adding inorganic filler and other additives, melting and kneading, extruding into a sheet shape, and film-forming by biaxial stretching method to form paper, can be used. As the synthetic resin of the main raw material, polypropylene, polystyrene, polyester, vinyl chloride or the like can be mentioned. Synthetic paper is superior to natural paper in properties such as strength, water-resistance, dimension stability, weather resistance, dust-free property or the like.

As a production method for the synthetic paper, in addition to the biaxial stretching method, a method in which split fiber is laminated to make paper, a method in which film having fine bubbles is made into paper, a method in which kinds of synthetic resin is cut short to obtain synthetic fiber paper by a conventional wet papermaking method, a method in which synthetic resin and cellulose fiber are mixed to obtain semi-synthetic fiber paper, a method in which papermaking is performed by a dry type production process of nonwoven fabric instead of conventional wet type, or the like can be mentioned.

Furthermore, a laminated paper in which thin film of the above-mentioned kinds of plastic film is layered on a wood pulp paper or synthetic paper, can be used as a substrate of the present invention. As a laminating method, a hot laminating method in which a film is heat-sealed by heating, a cold laminating method in which a film which can adhere at normal temperature is laminated, or any other method can be mentioned without being limited.

The anisotropic diffusing medium of the present invention includes an anisotropic diffusing layer which is made by curing the composition containing a photo-curable compound, as the composition, and the following combinations can be used.
(1) Single photopolymerizing compound described below is used
   (2) Plural photopolymerizing compounds described below are used in mixture
   (3) Single or plural photopolymerizing compound(s) and polymer compound not having photopolymerizing property are used in mixture

In any combination among the above, it seems that fine structures on the order of microns having different refractive indexes are formed in the anisotropic diffusing layer by light irradiation, and this mechanism seems to yield the special anisotropic diffusing properties of the present invention. Therefore, it is desirable that a change in refractive index before and after photopolymerization be large in the case of (1), and it is desirable that plural materials having mutually different refractive indexes be used together in the case of (2) and (3). It should be noted that changes in refractive index and differences in refractive index means specifically changes and differences not less than 0.01, desirably not less than 0.05, and more desirably not less than 0.10.

The photo-curable compound necessary to form the anisotropic diffusing medium comprises a photopolymerizing compound selected from polymers, oligomers, and monomers having a functional group with radical polymerizing properties or cationic polymerizing properties, and a photoinitiator. The material is polymerized and solidified by irradiating ultraviolet light or visible light.

The radical polymerizing compound has at least one unsaturated double bond in its molecule, specifically, an acrylic oligomer such as the so-called epoxy acrylate, urethane acrylate, polyester acrylate, polyether acrylate, polybutadiene acrylate, silicon acrylate or the like, and an acrylate monomer such as 2-ethylhexylacrylate, iso-amyl acrylate, butoxyethyl acrylate, ethoxydiethylene glycol acrylate, phenoxyethyl acrylate, tetrahydrofurfuryl acrylate, iso-norbornyl acrylate, 2-hydroxyethyl acrylate, 2-hydroxypropyl acrylate, 2-acryloyloxyphthalic acid, dicyclopentenyl acrylate, triethylenglycol diacrylate, neopentylglycol diacrylate, 1,6-hexanediol diacrylate, EO added diacrylate of bisphenol A, trymethylolpropane triacrylate, EO denatured trimethylolpropane triacrylate, pentaerythritol triacrylate, pentaerythritol tetraacrylate, ditrimethylolpropane tetraacrylate, dipentaerythritol hexaacrylate or the like, can be mentioned. These compounds can be used singly or plurally in mixture. It should be noted that methacrylates can also be used; however, acrylates are more desirable than methacrylates since the photopolymerization rates of acrylates are faster.

As the cationic polymerizing compound, a compound having at least one epoxy group, vinyl ether group or oxetane group in molecules thereof can be used. As a compound having an epoxy group, 2-ethylhexyldiglycolglycidyl ether, glycidyl ether of biphenyl, diglycidyl ethers of bisphenols such as bisphenol A, hydrogenerated bisphenol A, bisphenol F, bisphenol AD, bisphenol S, tetramethyl bisphenol A, tetramethyl bisphenol F, tetrachloro bisphenol A, tetrabromo bisphenol A or the like, polyglycidyl ethers of novolac resins such as phenol novolac, cresol novolac, phenol novolac bromide, ortho-cresol novolac or the like, diglycidyl ethers of alkylene glycols such as ethylene glycol, polyethylene glycol, polypropylene glycol, butanediol, 1,6-hexanediol, neopentyl glycol, trimethylol propane, 1,4-cyclohexane dimethanol, EO added bisphenol A, PO added bisphenol A or the like, and glycidyl esters such as glycidyl ester of hexahydrophthalic acid, diglycidyl ester of dimer acid or the like, can be mentioned.

Furthermore, alicyclic epoxy compounds such as 3,4-epoxycyclohexylmethyl-3′,4′-epoxycyclohexane carboxylate, 2-(3,4-epoxycyclohexyl-5,5-spiro-3,4-epoxy)cyclohexane-meta-dioxane, di(3,4-epoxycyclohexylmethyl)adipate, di(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxy cyclohexane), dicyclopentadiene diepoxide, di(3,4-epoxycyclohexylmethyl)ether of ethylene glycol, ethylenebis(3,4-epoxycyclohexane carboxylate), lactone denatured 3,4-epoxycyclohexylmethyl-3′,4′-epoxycyclohexane carboxylate, tetra(3,4-epoxycyclohexylmethyl)butane tetracarboxylate, di(3,4-epoxycyclohexylmethyl)-4,5-epoxytetrahydro phthalate or the like can be mentioned; however, they are not limited to these compounds.

As the compound having a vinyl ether group, for example, diethylene glycol divinyl ether, triethylene glycol divinyl ether, butanediol divinyl ether, hexanediol divinyl ether, cyclohexane dimethanol divinyl ether, hydroxybutylvinyl ether, ethylvinyl ether, dodecylvinyl ether, trimethylol propane trivinyl ether, propenyl ether propylene carbonate or the like can be mentioned, but they are not limited to these compounds. It should be noted that the vinyl ether compound has generally cationic polymerizing property; however, radical polymerizing can be performed by combining with acrylates.

As the compound having an oxetane group, for example, 1,4-bis[(3-ethyl-3-oxetanylmethoxy)methyl]benzene, 3-ethyl-3-(hydroxymethyl)-oxetane or the like can be used.

The above-described cationic polymerizing compounds can be used alone or plurally in mixture.

As the photoinitiator which can polymerize the radical polymerizing compound, benzophenone, benzyl, Michler's ketone, 2-chlorothio xanthone, 2,4-diethylthio xanthone, benzoin ethyl ether, benzoin iso-propyl ether, benzoin iso-butyl ether, 2,2-diethoxy acetophenone, benzyldimethyl ketal, 2,2-dimethoxy-1,2-diphenyl ethane-1-one, 2-hydroxy-2-methyl-1-phenyl propan-1-one, 1-hydroxycyclohexylphenyl ketone, 2-methyl-1-[4-(methylthio)phenyl]-2-morpholino propanone-1,1-[4-(2-hydroxyethoxy)-phenyl]-2-hydroxy-2-methyl-1-propane-1-one, bis(cyclopentadienyl)-bis(2,6-difluoro-3-(pil-1-il)titanium, 2-benzyl-2-dimethylamino-1-(4-morpholinophenyl)-butanone-1,2,4,6-trimethylbenzoyldiphenyl phosphine oxide or the like can be mentioned. These compounds can be used alone or plurally in mixture.

A photoinitiator for cationic polymerizing compounds generates acid by light irradiation, and the generated acid can polymerize the above-mentioned cationic polymerizing compound. Generally, an onium salt or metallocene complex is desirably used. As the onium salt, diazonium salt, sulfonium salt, iodonium salt, phosphonium salt, selenium salt or the like is used, and as a counter ion, an anion such as BF₄⁻, PF₆⁻, AsF₆⁻, SbF₆⁻ or the like can be used. Specifically, 4-chlorobenzendiazonium hexafluorophosphate, triphenylsulfonium hexafluoroantimonate, triphenylsulfonium hexafluorophosphate, (4-phenylthiophenyl)diphenylsulfonium hexafluoroantimonate, (4-phenylthiophenyl)diphenylsulfonium hexafluorophosphate, bis[4-(diphenylsulfonio)phenyl]sulfide-bis-hexafluoroantimonate, bis[4-(diphenylsulfonio)phenyl]sulfide-bis-hexafluorophosphate, (4-methoxyphenyl)diphenylsulfonium hexafluoroantimonate, (4-methoxyphenyl)phenyliodonium hexafluoroantimonate, bis(4-t-butylphenyl)iodonium hexafluorophosphate, benzyltriphenylphosphonium hexafluoroantimonate, triphenylselenium hexafluorophosphate, (η5-isopropylbenzene)(η5-cyclopentadienyl)iron(II) hexafluorophosphate or the like can be mentioned, but they are not limited to these compounds. These compounds can be used alone or plurally in mixture.

In the present invention, the above-mentioned photoinitiator is added at about 0.01 to 10 parts by weight, desirably about 0.1 to 7 parts by weight, and more desirably about 0.1 to 5 parts by weight to 100 parts by weight of the photopolymerizing compound. If the added amount is less than 0.01 parts by weight, the photo-curable property is decreased, and if the added amount is more than 10 parts by weight, only the surface is cured and the inside remains with a low level of curing property. These photoinitiators are used by directly dissolving the powder of the photoinitiator into the photopolymerizing compound. In the case in which solubility is low, the photoinitiator is dissolved beforehand into an extremely small amount of solvent to make a solution of high concentration, and the solution can be used. As the solvent, a solvent having photopolymerizing property is more desirable, specifically, propylene carbonate, γ-butyrolactone or the like can be mentioned. In addition, to improve photopolymerizing property, conventional dyes or sensitizing agents can be added. Furthermore, a thermo-curable initiator which can harden the photopolymerizing compound by heating can be used with the photoinitiator. In this case, by heating after photo-polymerizing, polymerizing and curing of the photo-polymerizing compound can be perfectly promoted.

In the present invention, the anisotropic diffusing layer can be formed by curing the above-mentioned photo-curable compound alone or a composition made of a plural mixture. In addition, the anisotropic diffusing layer of the present invention can also be formed by curing a mixture of the photo-curable compound and a polymer resin not having a photo-curable property. As a resin which can be used, acrylic resin, styrene resin, styrene-acrylic copolymer, polyurethane resin, polyester resin, epoxy resin, cellulose type resin, vinyl acetate type resin, vinyl chloride-vinyl acetate copolymer, polyvinyl butyral resin or the like can be mentioned. These polymer resins and photo-curable compounds are required to have sufficient compatibility, and kinds of organic solvents, plasticizing agents or the like can be used to obtain the compatibility. It should be noted that in the case in which acrylate is used as a photo-curable compound, acrylic resin is desirable as the polymer resin from the viewpoint of compatibility.

The anisotropic diffusing medium of the present invention is produced by forming the composition containing the above-mentioned photo-curable compound into a sheet shape, and irradiating collimated light from the direction of line P to this sheet to harden the composition. As a method to form the composition containing the photo-curable compound on a substrate, a conventional coating method or printing method can be performed. Practically, a coating method such as air doctor coating, bar coating, blade coating, knife coating, reverse coating, transfer roll coating, gravure roll coating, kiss coating, cast coating, spray coating, slot orifice coating, calender coating, dam coating, dip coating, dye coating or the like, intaglio printing such as gravure printing or the like, stencil printing such as screen printing can be used. In the case in which the composition has low viscosity, a dam having a certain height is arranged around the substrate, and the composition can be cast into the area surrounded by the dam.

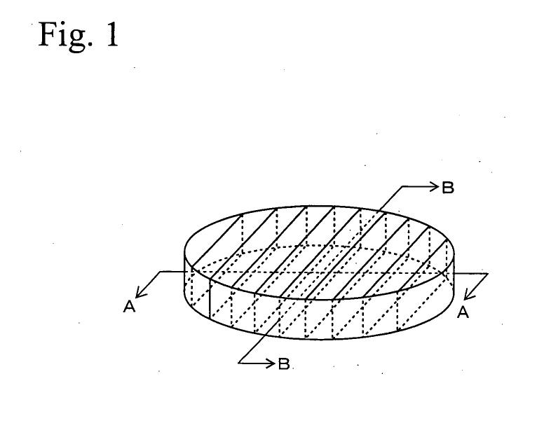

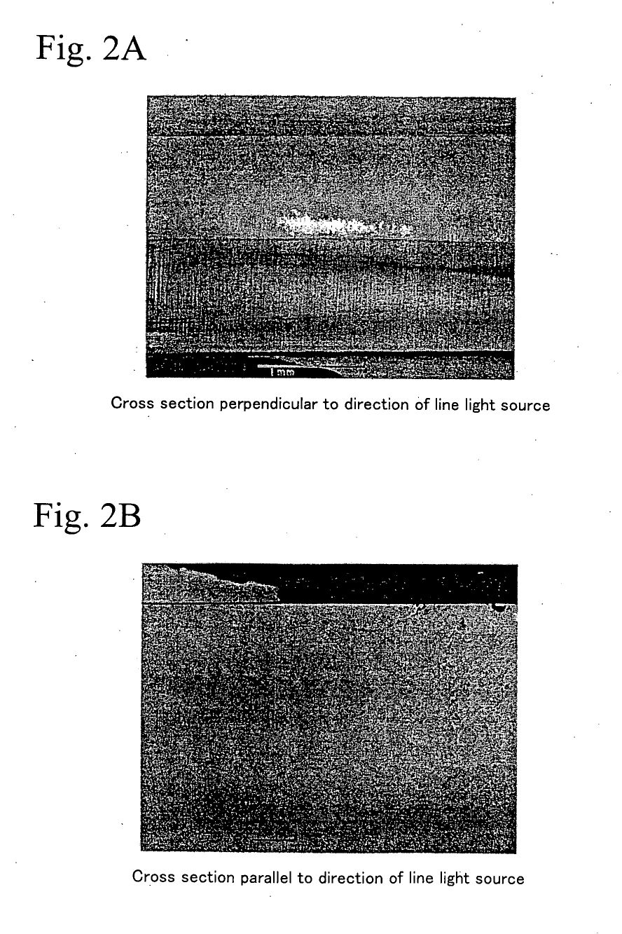

As a light source to perform irradiation on the sheet of the composition containing a photo-curable compound, an ultraviolet light generating light source of short arc is usually used, and practically, a high pressure mercury lamp, low pressure mercury lamp, metal halide lamp, xenon lamp or the like can be used. It should be noted that a light source having an emission surface with a bar-shape is undesirable in the present invention. If the bar-shaped light source is used, a plate-shaped cured area is formed, and conventional anisotropic diffusing mediums as shown in FIGS. 1, 2, and 14 are undesirably obtained. In the present invention, it is necessary that collimated light be irradiated from a specific direction (line P) to the sheet of composition containing the photo-curable compound, and it is desirable to use an exposing device used during the exposure of a resist. In the case in which one having a small size is produced, it is possible to perform irradiation from a substantial distance using an ultraviolet light spot light source.

Light which is irradiated to a sheet-shaped composition containing a photo-curable compound is required to have a wavelength which can harden the photo-curable compound. Usually, a light mainly having a wavelength of 365 nm from a mercury lamp is used. To produce the anisotropic diffusing layer of the present invention using the wavelength range illumination intensity is desirably in a range from 0.01 to 100 mW/cm², and more desirably in a range from 0.1 to 20 mW/cm². If the illumination intensity is less than 0.01 mW/cm², it would take a long time to harden, and production efficiency would decrease, whereas on the other hand, if the illumination intensity is more than 100 mW/cm², curing of the photo-curable compound is too rapid and the structure of the present invention cannot be obtained, and the target anisotropic diffusing property cannot be exhibited.

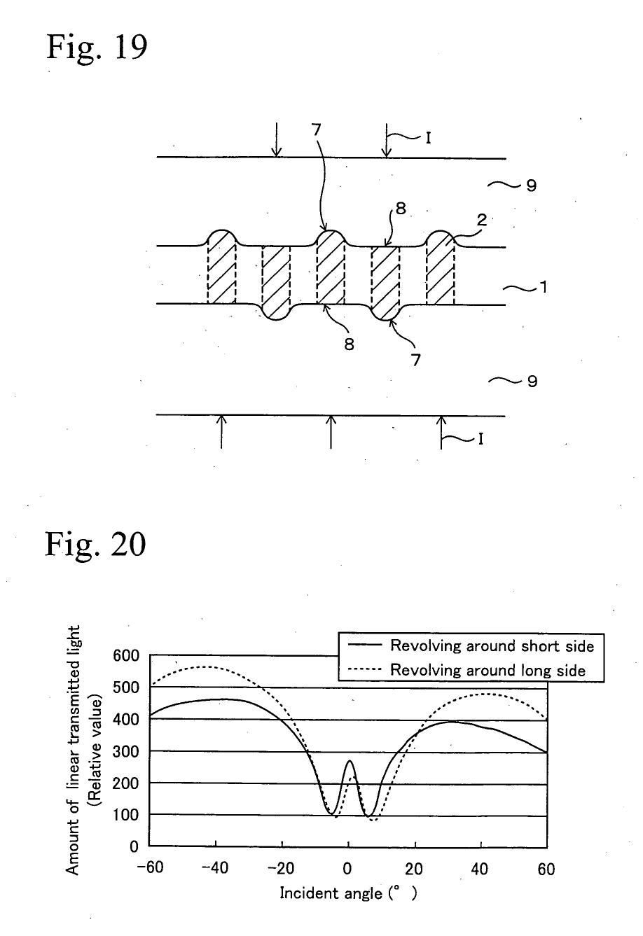

Selection of substrate and method of light irradiation to produce the anisotropic diffusing medium of the present invention can be performed as follows, for example. One example is a composition containing a photo-curable compound is arranged in the shape of a sheet on a flexible film substrate 10, another transparent substrate is arranged thereon if necessary, and light irradiation is performed from below. In this case, convex and concave parts are generated on a cured surface of the lower side (side of flexible film) of the composition containing a photo-curable compound, and as a result, the composition and the flexible film are easily separated. Therefore, the flexible film is not necessarily transparent (see FIG. 17). Another example is a similar composition containing a photo-curable compound arranged on a substrate having high transparency, and light irradiation is performed from the side of transparent film not covering the surface of the composition with another substrate. In this case, pillar-shaped cured, areas begin growing from the side of the transparent substrate and continue growing until the component which is not yet cured is used up. Therefore, the largest surface convex and concave parts are formed compared to other cases using the same composition (see FIG. 18). Furthermore, a method in which a composition containing a photo-curable compound is placed between two transparent flexible films and light irradiation is performed from both sides of the transparent flexible films to form surface convex and concave parts on both sides, is possible (see FIG. 19)

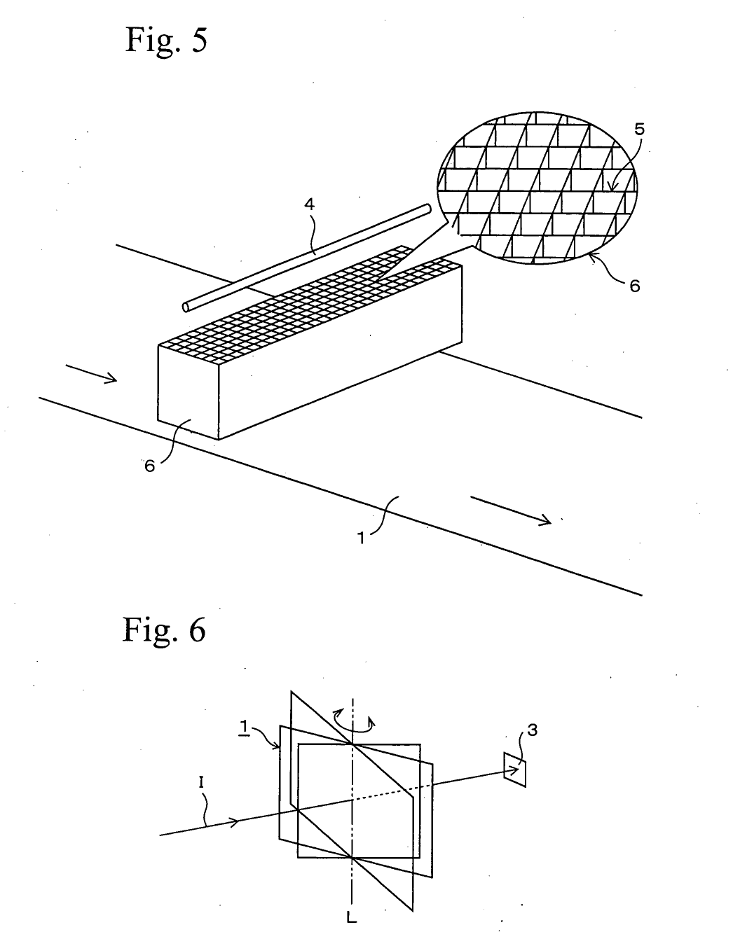

In the production method of the anisotropic diffusing medium of the present invention, to produce a medium having an internal structure and optical properties of the present invention by using a linear light source which is often used in a coating device or printing device, not by using a point light source, aggregation of tubular members arranged collimated to the direction P is placed between the linear light source and a sheet-shaped composition containing a photo-curable compound, and light irradiation is performed through the tubular members. The tubular member is one having a cavity inside and openings at both ends, like paper rolled into a cylindrical shape. By arranging a large number of the tubular members all oriented in the same direction, and by passing light from the linear light source through the tubular members to irradiate the composition, the irradiated condition at an arbitrary point of the sheet-shaped composition containing photo-curable compounds would be similar to a condition in which the composition is irradiated from the conventional point light source, and therefore the optical properties would also be the same. A schematic diagram showing light irradiation using such a tubular member is shown in FIGS. 4 and 5.

A shape of a cross section of the tubular member used in the production method of the present invention is not limited in particular, and a circle, triangle, quadrangle, hexagon, or combination thereof can be mentioned. The diameter of the cross section of each tubular member is desirably in a range from 1 to 100 mm, and the length is desirably in a range from 10 to 1000 mm. Furthermore, the diameter of the cross section D and the length L satisfy the relationship L/D>5, desirably L/D>10, and more desirably L/D>20. If the diameter of the tubular member is less than 1 mm, the amount of light passing through the tubular member is too small, whereas on the other hand, if the diameter of the tubular member is more than 100 mm, the degree of collimated of light is not sufficient, and it can no longer provide irradiating conditions similar to that of a conventional point light source. If the length is less than 10 mm, it can no longer provide irradiating conditions similar to that of a conventional point light source, whereas on the other hand, if the length is more than 1000 mm, the intensity of light irradiated on the composition containing photo-curable compounds would be small, and a long exposure is required, which is undesirable.

It is necessary that one end of the aggregations of the tubular members be positioned very near the linear light source and the other end be positioned near the sheet-shaped composition containing the photo-curable compound. If one end or both ends are far from the linear light source or the sheet-shaped composition, the light irradiated to the sheet-shaped composition exhibits a linear shape reflecting the shape of the linear light source, or light from a tubular member is mixed with light from another neighboring tubular member, and desirable irradiating conditions from a point light source cannot be reproduced. As a result, the anisotropic diffusing medium of the present invention cannot be produced.

Materials for the tubular member and the aggregations thereof used in the present invention are not limited in particular, and glass, ceramic, metal, plastic or the like can be used, and in particular, a material having durability against strong light and heat from the linear light source and having great physical strength, is desirable. Practically, metal or an alloy such as SUS, iron, aluminum or the like, or heat-resistant polymer material is desirably used. However, the inside of the tubular member, through which the light is transmitted, is desirably treated not to reflect light, such as by being coated black, by the metal being subjected to blackening treatment, or by being subjected to electrostatic flocking.

The above-explained aggregation of the tubular members is arranged near the sheet-shaped composition containing photo-curable compounds. Since light irradiated through the aggregation of the tubular members is an aggregation of spot light depending on the cross section of the tubular members, there are portions of weak irradiation strength between each spot. Therefore, it is desirable that the aggregation of the tubular members and sheet-shaped composition containing photo-curable compound be relatively moved to make the overall irradiation strength uniform. Practically, the aggregation of the tubular members can be shuttled right and left while fixing the orientation of the direction P, or the aggregation can be rotated on a circular orbit.

In the case in which continuous production is performed, when an elongate product of the composition containing a photo-curable compound is moved at constant speed, light is irradiated from a linear light source and aggregations of tubular members are arranged collimated to the width direction of the elongated product. To increase the curing rate, the linear light sources and aggregations of tubular members are plurally and serially arranged. In this case, to make the amount of irradiation in the width direction uniform, the direction of an edge of a shape of a cross section of the tubular member such as a triangle, quadrangle, hexagon or the like, is made to be different compared to the moving direction of the elongated product. Alternatively, it is effective for a mechanism for shuttling right and left or rotating circularly to be added to the aggregation of the tubular members.

As a light source to perform light irradiation in the method of the present invention as explained above, a light source having a bar-shaped emission surface is used, and practically, a high pressure mercury lamp, low pressure mercury lamp, metal halide lamp, xenon flash lamp or the like can be used. As the bar-shaped light source, one having a diameter of about 20 to 50 mm and emission length of about 100 to 1500 mm is commercially available, and it can be selected according to the size of the anisotropic diffusing medium to be produced.

### EXAMPLES

### 1. First Embodiment

### Example 1

A division wall having a height of 0.5 mm was formed around an edge of a slide glass having a size of 76×26 mm with curable resin using a dispenser. The following composition of ultraviolet light curable resin was dropped in the area surrounded by the wall, and this was covered by another slide glass.

EO denatured trimethyrolpropane triacrylate (Trade name: Light acrylate, TMP-6EO-3A, produced by Kyoei Kagaku Kogyo) 100 parts by weight

2-hydroxy-2-methyl-1-phenylpropan-1-one (Trade name: Darocure1173. produced by Ciba Specialty Chemicals) 4 parts by weight

Ultraviolet light having an irradiation intensity of 30 mW/cm² was irradiated from an epi-irradiation unit with a UV spot light source (Trade name: L2859-01, produced by Hamamatsu Photonics) vertically to the liquid membrane having a thickness of 0.5 mm placed between the slide glasses for 1 minute. Removing the slide glasses on both surfaces, the anisotropic diffusing medium of the present invention was obtained.

### Comparative Example 1

Ultraviolet light having an irradiation intensity similar to that of the Example was irradiated from a linear UV source (Trade name: Handy UV device HUV-1000, produced by Japan UV Machine) vertically to the composition of ultraviolet curing similar to that of the Example placed between the slide glasses. Removing the slide glasses on both surfaces, the anisotropic diffusing medium was obtained. It should be noted that the longitudinal direction of the linear UV light source was conformed to the direction of the short edge of the slide glass.

Using a goniophotometer (Trade name: GP-5, produced by Murakami Color Research Laboratory), a light receiving part was fixed at a position to receive straight traveling light from a light source, and the anisotropic diffusing media of Example 1 and Comparative Example 1 were set in a sample holder between the light source and the light receiving part. As shown in FIG. 13, the short edge of the slide glass used during production of the anisotropic diffusing medium was defined as a revolving axis (L), the sample was revolved and the amount of linear transmitted light corresponding to each incident angle was measured, and this test was called “revolving around the short side”. Next, the sample was removed from the sample holder, the sample was revolved 90 degrees in the surface and the sample was again set to the holder. This time, the amount of linear transmitted light when revolving around the long edge of the slide glass, that is, a revolving axis (M), was measured and this test was called “revolving around the long side”.

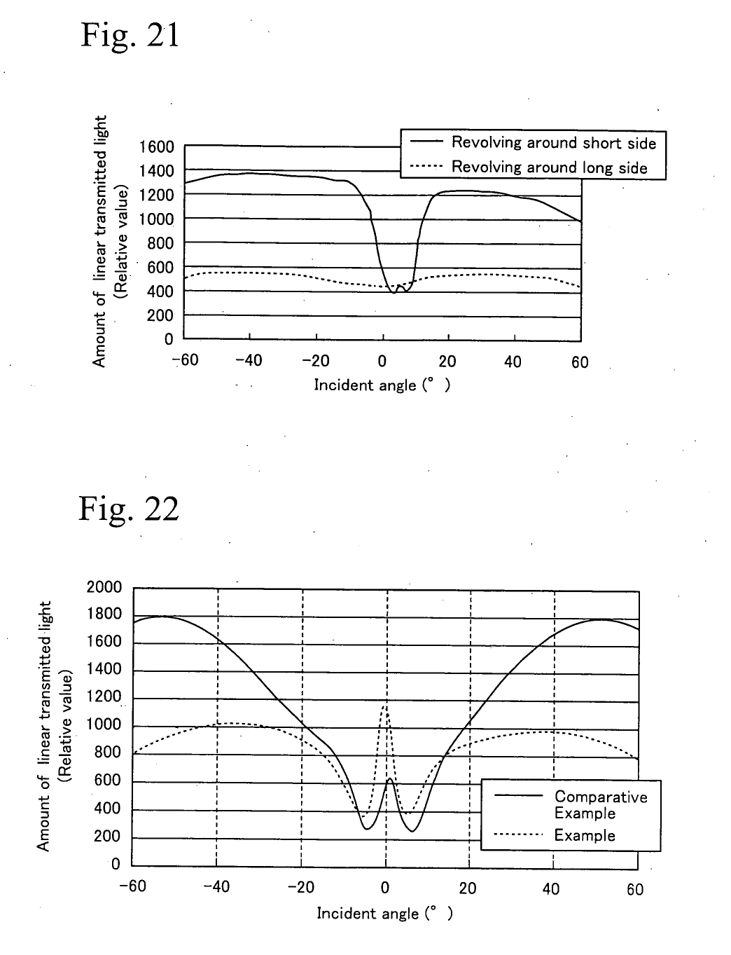

Regarding the anisotropic diffusing media of Example 1 and Comparative Example 2, the relationship of the incident angle and the amount of the linear transmitted light measured concerning the two revolving axes, is shown in FIGS. 20 and 21. In Example 1, a deep valley having a small peak at an incident angle of 0 degrees is exhibited in both the “revolving around the short side” and “revolving around the long side”, and the graph is almost bilaterally symmetric. On the other hand, in the anisotropic diffusing medium of the Comparative Example 1, the situation is very different between “revolving around the short side” and “revolving around the long side”. That is, in the revolving around the short side, a valley shape similar to that in Example 1 was observed, and in the revolving around the long side, the amount of linear transmitted light was little changed even if the incident angle was varied.

### 2. Second Embodiment

### Comparative Example 2

A division wall having a height of 0.5 mm was formed around an edge of a slide glass having a size of 76×26 mm with a curable resin using a dispenser. The following composition of an ultraviolet curable resin was dropped in the area surrounded by the wall, and this was covered by another slide glass.

EO denatured trimethyrolpropane triacrylate (Trade name: Light acrylate, TMP-6EO-3A, produced by Kyoei Kagaku Kogyo) 100 parts by weight

2-hydroxy-2-methyl-1-phenylpropan-1-one (Trade name: Darocure1173. produced by Ciba Specialty Chemicals) 1 part by weight

Ultraviolet light having an irradiation intensity of 30 mW/cm² was irradiated from an epi-irradiation unit of a UV spot light source (Trade name: L2859-01, produced by Hamamatsu Photonics) vertically 30 cm to the liquid membrane having a thickness of 0.5 mm placed between the slide glasses for 10 seconds. Removing the slide glasses on both surfaces, the anisotropic diffusing medium having a smooth surface was obtained.

### Example 2

Except that a separating PET film having a thickness of 75 μm was used instead of one of the two slide glasses, the anisotropic diffusing medium was produced in a manner similar to that of Comparative Example 2. It should be noted that the ultraviolet light was irradiated from a side of the slide glass.

Regarding the anisotropic diffusing media obtained in Comparative Example 2 and Example 2, surface roughnesses measured according to JIS B 0601-1994 are shown in Table 1.

TABLE 1

| | | | Front side | Back side |
|---|---|---|---|---|
| | | | (UV incident | (UV exit |
| | Characteristic | | side) | side) |
| Comparative | Arithmetic average | Ra | 0.06 μm | 0.12 μm |
| Example 2 | roughness: | | | |
| | Maximum height: | Ry | 0.48 μm | 0.82 μm |
| | Average separation | Sm | 1880 μm | 22.7 μm |
| | of convex and | | | |
| | concave parts: | | | |
| Example 2 | Arithmetic average | Ra | 0.04 μm | 0.18 μm |
| | roughness: | | | |
| | Maximum height: | Ry | 0.36 μm | 1.32 μm |
| | Average separation | Sm | 2220 μm | 29.1 μm |
| | of convex and | | | |
| | concave parts: | | | |

As is clear from Table 1, the anisotropic diffusing medium has a mirror gloss at the front side and has convex and concave parts at the back side. Furthermore, the degree of surface roughness in the case in which a soft PET film (Example 2) is contacted to the back side, is larger than that in the case in which hard glass (Comparative Example 2) is contacted.

Next, using a goniophotometer (Trade name: GP-5, produced by Murakami Color Research Laboratory), a light receiving part was fixed at a position for receiving straight traveling light from a light source, and the anisotropic diffusing media of Example 2 and Comparative Example 2 were set in a sample holder between the light source and the light receiving part, the samples were revolved, and the amount of linear transmitted light corresponding to each incident light was measured. The results are shown in FIG. 22.

Comparative Example 2 remarkably exhibits anisotropic diffusing properties resulting from the internal structure, and the difference of the maximum value and the minimum value of the amount of linear transmitted light is large. On the other hand, since the effect of surface convex and concave parts is added to the anisotropic diffusing property resulting from the internal structure in Example 2, the difference of the maximum value and the minimum value of the amount of linear transmitted light is extremely small, and the peak of the amount of linear transmitted light around 0 degrees is remarkably large.

1-12. (canceled)

13. An anisotropic diffusing medium having a resin layer comprising a cured composition containing a photo-curable compound,
wherein an aggregation of plural pillar-shaped cured areas is formed inside the resin layer,
wherein the plural pillar-shaped cured areas all extend collimated to a specific direction P, and
wherein in the case in which an amount of each linear transmitted light corresponding to each incident light from all directions to an arbitrary input point on one side of the anisotropic diffusing medium are displayed by vectors beginning at an output point on the other side of the anisotropic diffusing medium corresponding to the input point to each direction of output, the rounded surface obtained by connecting the top of the vectors is a bell-shaped rounded surface having a symmetric axis of direction P.

14. The anisotropic diffusing medium according to claim 13, wherein the specific direction P is a normal line S to the surface of the anisotropic diffusing medium.

15. An anisotropic diffusing medium comprising a transparent substrate and the anisotropic diffusing medium according to claim 13 layered thereon.

16. An anisotropic diffusing medium comprising a transparent substrate and the anisotropic diffusing medium according to claim 14 layered thereon.

17. An anisotropic diffusing medium comprising the anisotropic diffusing medium according to claim 13 and transparent substrates layered on both surfaces of the anisotropic diffusing medium.

18. An anisotropic diffusing medium comprising the anisotropic diffusing medium according to claim 14 and transparent substrates layered on both surfaces of the anisotropic diffusing medium.

19. A production method for an anisotropic diffusing medium, the method comprising:
forming a composition containing a photo-curable compound into a sheet shape, and
irradiating collimated light from a specific direction P to the sheet shape composition to harden the composition and form an aggregation of plural pillar-shaped cured areas extending along the specific direction P in the sheet.

20. An anisotropic diffusing medium having a resin layer comprising a cured composition containing a photo-curable compound,
wherein an aggregation of plural pillar-shaped cured areas is formed inside the resin layer,
wherein the plural pillar-shaped cured areas all extend collimated to a specific direction P,
wherein convex and concave parts are formed on at least one surface of the resin layer, and
wherein an arithmetic average roughness Ra and a maximum height of the convex and concave parts Ry satisfy the following formulas (1) and (2):
0.15 μm≦Ra≦1.0 μm (1)
1.0 μm≦Ry≦5.0 μm (2).

21. The anisotropic diffusing medium according to claim 20, wherein the specific direction P is a normal line S to the surface of anisotropic diffusing medium.

22. An anisotropic diffusing medium comprising a transparent substrate and the anisotropic diffusing medium according to claim 20 layered thereon.

23. An anisotropic diffusing medium comprising a transparent substrate and the anisotropic diffusing medium according to claim 21 layered thereon.

24. A production method for an anisotropic diffusing medium, the method comprising:
forming a composition containing a photo-curable compound into a sheet shape, and
irradiating collimated light from the direction P to the sheet-shaped composition to harden the composition.

25. The production method for an anisotropic diffusing medium according to claim 23, wherein an output surface of the collimated light in the composition is exposed to the air or is covered with a flexible sheet during curable of the composition by irradiating the collimated light from the direction of line P.

26. A production method for an anisotropic diffusing medium, the method comprising:
forming a composition containing a photo-curable compound into a sheet shape, and
irradiating collimated light from a linear light source at a specific direction P to the sheet-shaped composition to harden the composition and form a an aggregation of plural pillar-shaped cured areas extending along the specific direction P in the sheet,
wherein an aggregation of tubular members collimated to the direction P is arranged between the linear light source and the sheet, and
wherein light irradiation is performed through the tubular members.

27. The production method for an anisotropic diffusing medium according to claim 26, wherein the specific direction P is a normal line S to the surface of anisotropic diffusing medium.
